(19) United States
(12) Patent Application Publication
(10) Pub. No.: US 2003/0070727 A1
(43) Pub. Date: Apr. 17, 2003

(54) Multi-purpose tool system

(76) Inventor: Michael R. Stephens, Hillsboro, OR (US)

Correspondence Address: Kolisch, Hartwell, Dickinson,, McCormack & Heuser, 200 Pacific Building, 520 S.W. Yamhill Street, Portland, OR, 97204, US

(21) Appl. No.: 09/982,311

(22) Filed: Oct. 17, 2001

(51) Int. Cl. B27C 9/00

(52) U.S. Cl. 144/1.1

(57) ABSTRACT

A multi-purpose tool system including a workpiece support assembly and tool mount assembly operatively secured to a base structure. The tool mount assembly and workpiece support assembly typically are configured to be movable to provide tools and workpieces supported by those structures with a wide variety of movements relative to the base structure. In particular, the tool mount assembly may be configured to permit rotation of a tool mounted thereon about multiple axes of rotation relative to the base structure. In addition, the base structure may be configured to include a way assembly having one or more elongate way members, where the way assembly is modular to permit selective insertion and removal of one or more additional elongate way members to provide the way assembly with an adjustable length.

### FIELD OF THE INVENTION

The invention relates to a multi-purpose tool system including a tool mount assembly adapted to permit mounting of a variety of different tools thereon. The tool mount assembly typically is secured to a base so as to permit a mounted tool to be moved relative to the base in a variety of different ways.

### BACKGROUND OF THE INVENTION

Manufacturers of consumer woodworking and machine tools provide a wide array of single function tools. A large number of these single function tools must be purchased to meet the varied demands of a well-equipped shop. In addition to high acquisition costs, these tool systems present problems relating to storage and transportation. For example, hobbyists typically are constrained by limited space within which to use and store tools, and traveling tradesmen have limited cargo space in their vehicles.

To address these issues, various multi-purpose tool machines have been proposed. Examples of such machines are described in U.S. Pat. Nos. 4,349,945, 2,623,269, 5,562,135, 4,779,857, 4,830,069, and 4,515,191, the disclosures of which are incorporated herein, in their entirety and for all purposes, by this reference.

Though many prior designs provide multi-function capability, many such designs are quite complicated. In multi-purpose tool systems, the complexity tends to increase with the number of available options. As such, the systems that provide the most options tend to be the most complicated and expensive.

In addition, even the more flexible systems tend to be limited to a small number of fairly constrained configurations. For example, many systems have various components movably mounted on a rail system to selectively provide either a table saw or drill press configuration. Often these systems do not allow for configurations other than the table saw and drill press. Also, the drill press depth/travel is often very limited in conventional systems of this type, and the saw configurations typically limit the saw blade to being positioned only in certain conventional orientations relative to the rail system.

A related drawback is that many prior systems are suited only to a particular scale, and are not appropriate for use in other settings. For example, some systems are appropriate only for small-scale applications, such as home/hobby or benchtop uses. Other systems are much bigger and thus suited only to large-scale industrial applications.

In addition to these drawbacks, many existing systems suffer from limited portability. Although some multi-purpose tool systems are provided with wheels, the weight and volume of these systems substantially limits their movabiliy. For instance, many existing systems may be rolled from one end of a shop to the other, but are too heavy or bulky to be readily loaded onto a pickup truck by a single person. None of the existing designs have the ability to fold into a compact space for storage or easy transportation.

### SUMMARY OF THE INVENTION

The present invention provides a multi-purpose tool system including a workpiece support assembly and tool mount assembly operatively secured to a base structure. The tool mount assembly and workpiece support assembly typically are movable, in order to enable tools and/or workpieces supported by those structures to be moved in a variety of ways relative to the base structure. In particular, the tool mount assembly may be configured to permit rotation of a tool mounted thereon about multiple axes of rotation relative to the base structure. One or both of the tool mount assembly and workpiece assembly may be movably secured to the base structure so as to translate lengthwise along the base structure. In addition, the base structure may be configured to include a way assembly having one or more elongate way members, where the way assembly is modular to permit selective insertion and removal of one or more additional elongate way members to provide the way assembly with an adjustable length.

### BRIEF DESCRIPTION OF THE DRAWINGS

FIG. 1 is an isometric view of a multi-purpose tool system according to the present invention.

FIG. 2 is another isometric view of the tool system of FIG. 1.

FIG. 3 is another isometric view of the tool system of FIG. 1, showing an alternate configuration of the tool system components.

FIG. 4 is an isometric view of a workpiece support assembly which may be used with the tool system of FIG. 1.

FIG. 5 is an isometric view of a tool mount assembly which may be used with the tool system of FIG. 1.

FIG. 6 is an isometric view of a base structure, or way assembly, which may be used with the tool system of FIG. 1.

FIG. 7 is an isometric view depicting the tool system of FIG. 1 in a stowed configuration.

FIG. 8 is an isometric view a tool system according to the present invention, as configured for a drill press application.

FIG. 9 is a side view of a tool system according to the present invention, as configured for a lathe application.

FIG. 10 is a side view of a tool system according to the present invention, showing a tool rest component which may be employed in lathe applications (depicted) or other types of applications.

FIG. 11 is an isometric view of a tool system according to the present invention, as configured for an unconventional saw application in which the saw blade is parallel to the workpiece support surface.

FIG. 12 is an isometric view of a tool system according to the present invention, as configured for a joiner application.

### DETAILED DESCRIPTION OF THE INVENTION

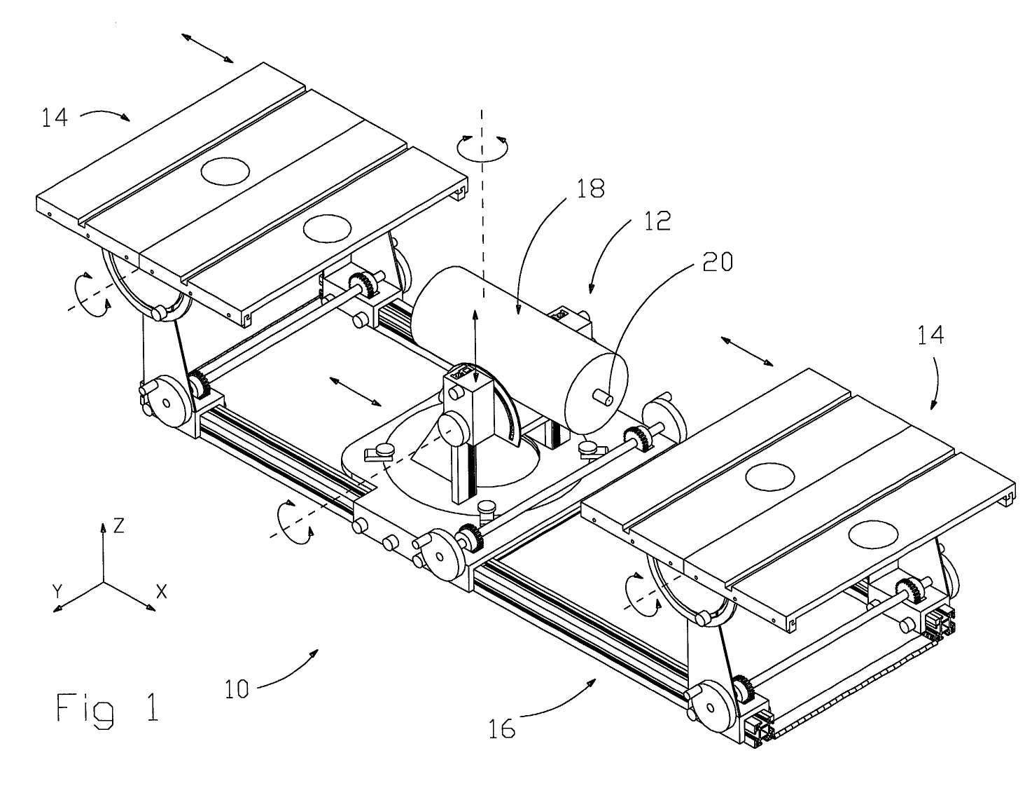

FIG. 1 depicts a multi-purpose tool system 10 according to the present invention. Tool system 10 includes a tool mount assembly 12 configured to permit mounting of a variety of different tools thereon, and one or more workpiece support assemblies 14. Tool mount assembly 12 and workpiece support assemblies 14 typically are movable relative to base 16, enabling tool system 10 to be placed in a wide variety of configurations. In a typical configuration, the tool system is configured to enable a tool (e.g., a saw blade) mounted on the tool mount assembly to act upon a workpiece (e.g. a piece of wood) resting on the workpiece supports.

Tool mount assembly 12 typically is configured to permit a variety of different movements relative to base 16. For example, as indicated in FIGS. 1-3, tool mount assembly 12 may be configured to translate in one or more directions relative to base 16. Specifically, the depicted tool mount assembly is movably secured to base 16 to permit translation of a tool secured to the tool mount assembly relative to the base in both a horizontal and a vertical direction. The horizontal and vertical directions respectively correspond to the x- and z-directions indicated in the legends accompanying FIGS. 1-3. It should be further understood that tool mount assembly 12 may be designed to permit relative translation along the y-axis, or in any other desired direction(s). Depending on the application, tool mount assembly 12 may be configured for single or multiple axis translation relative to base 16. Various structures that may be used to provide relative translation between tool mount assembly 12 and base 16 will be described below.

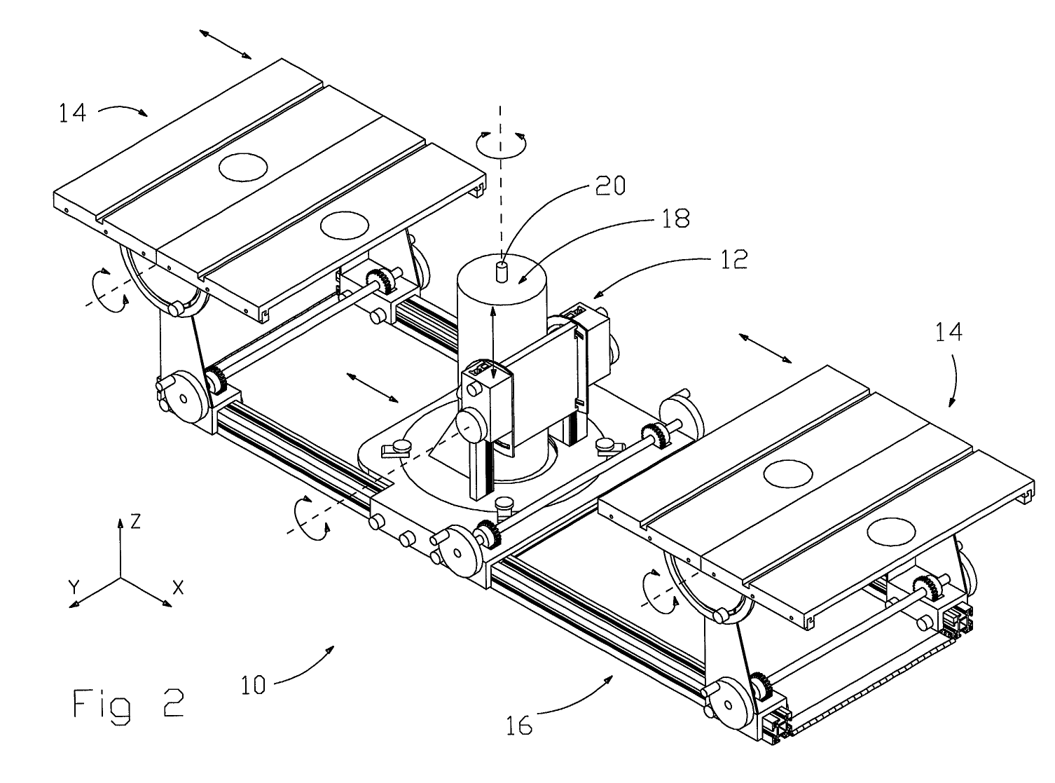

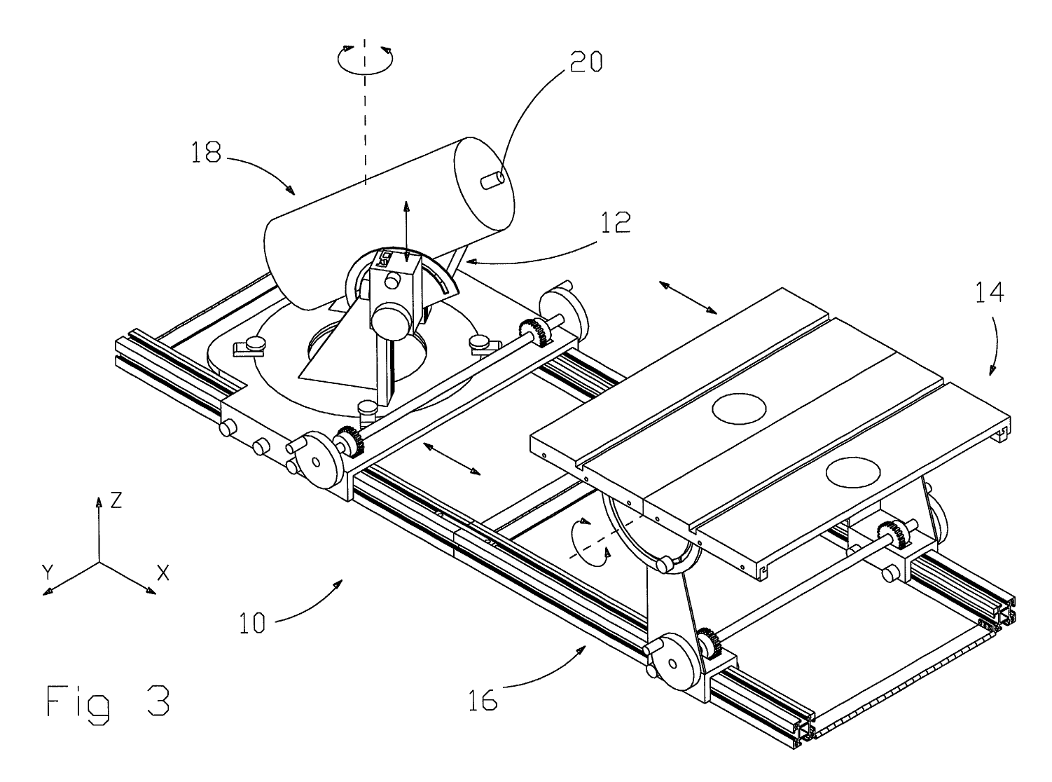

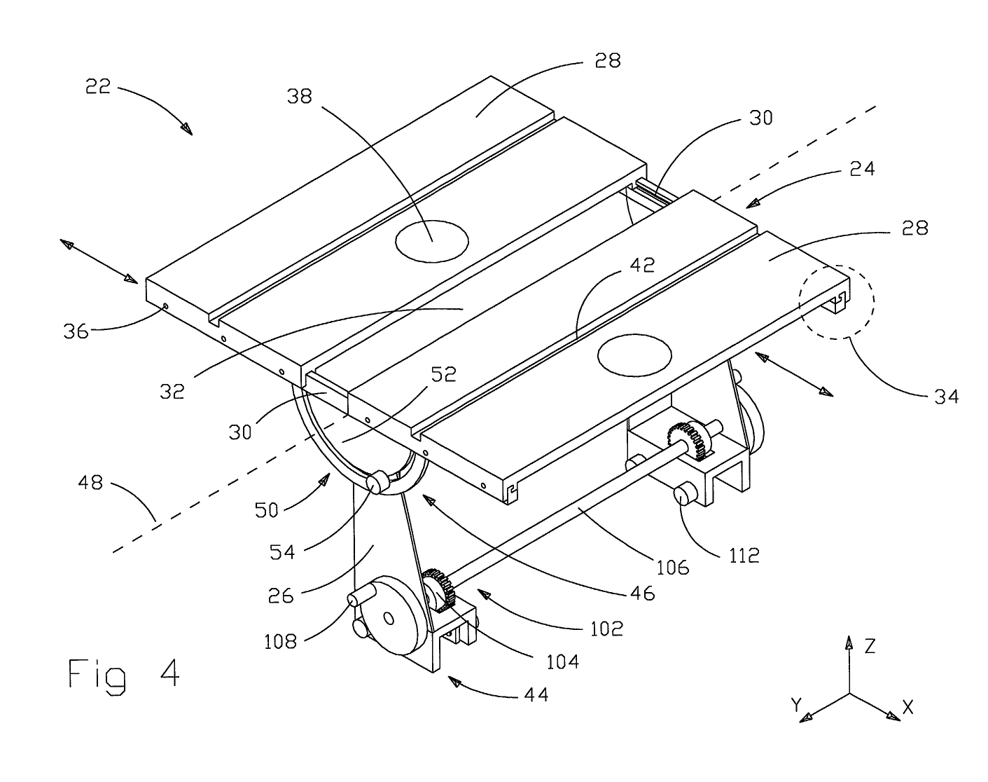

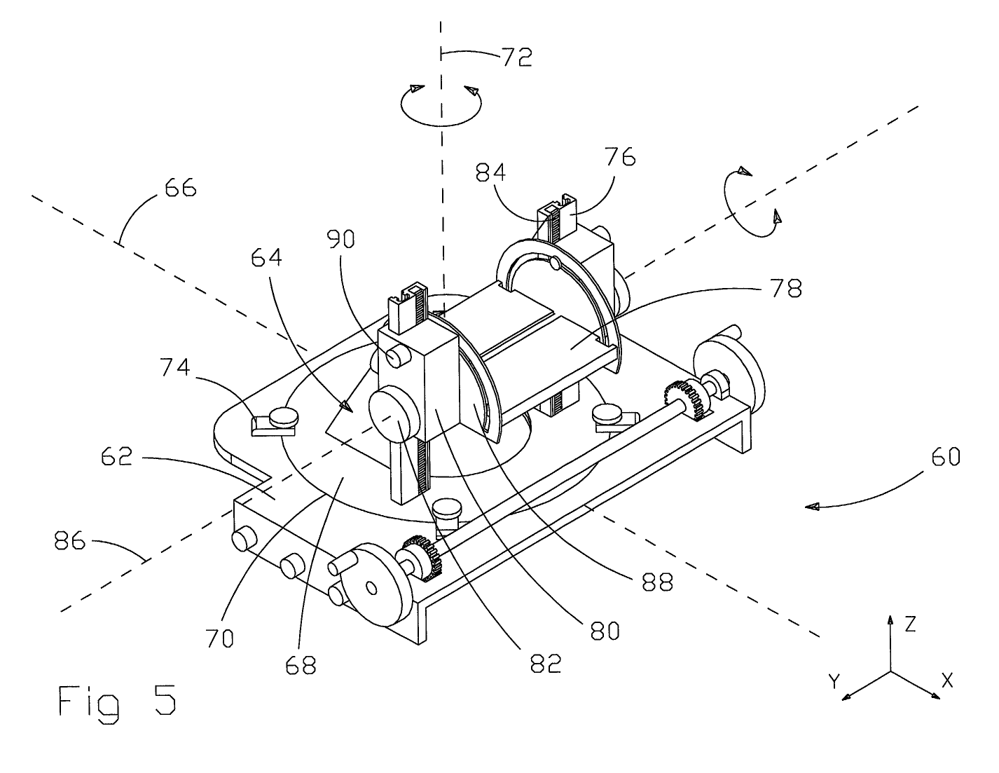

Tool mount assembly 12 typically is also adapted to permit rotation of a mounted tool relative to base 16, in addition to, or instead of, the translational movements described above. For example, as indicated, tool mount assembly 12 is configured to allow rotation about both the z- and y-axes. For example, FIG. 2 depicts tool mount assembly rotated ninety degrees about the y-axis from the position shown in FIG. 1. FIG. 3 depicts the tool mount assembly in a position in which it has been rotated about both the y- and z-axes from the position shown in FIG. 1. It should be appreciated that such a two-axis system provides an at least partially spherical range of motion relative to base 16 for a mounted tool.

This spherical range of motion is best illustrated by reference to FIG. 3. As in FIGS. 1 and 2, FIG. 3 depicts an optional motor 18 included as part of tool mount assembly 12. Motor 18 has an output shaft 20, which typically is configured to receive a variety of different tool components, such as a grinder wheel, shaping implement, lathe bit, saw blade, etc. With a two-axis rotating mechanism, such as that provided by tool mount assembly 12, output shaft 20 acts as a radius of the sphere, and may be pointed in any desired radial direction via adjustment of the tool mount assembly. Specific structures for rotating tool mount assembly 12 relative to base 16 will be described below. As an alternative to the depicted two-axis spherical system, tool mount assembly 12 may be configured to provide tool rotation about more or less than two axes. In systems with two or more axes, the rotational axes may be perpendicular to one another, as in the depicted system, or configured in any other suitable orientation.

In addition to, or instead of, the translational and rotational movements described above, the entire tool system may be positioned relative to a ground surface in positions other than the position shown in FIG. 1. As will be described in more detail below, the entire tool system may be rotated relative to the ground surface and rested on one of its ends or sides.

An embodiment of a workpiece support assembly which may be employed with the present invention is depicted at 22 in FIG. 4. Typically, the assembly includes a workpiece support 24, platform or like structure configured to support wood, metal or other workpieces to be acted upon. In addition to workpiece support 24, assembly 22 typically includes one or more legs 26 extending between the base of the tool system and the workpiece support.

The actual supporting structure of the assembly (i.e., workpiece support 24) may be formed in a variety of different configurations. In some cases, it will be desirable to form the workpiece support as an unbroken planar expanse. Alternatively, as in the depicted example, workpiece support 24 may be provided with multiple sections 28 movably coupled via guide structures. Use of such support surface sections may be desirable to provide an adjustable workpiece support, and/or to enhance the flexibility and scalability of the tool system.

Where guide structures (e.g., rails 30) and support surface sections are used, the support surface sections typically are movable as indicated in the figure along the guide structures. Translation along the guide structures may be provided via a sliding interface, gears, or any other suitable structure. In any event, the relative movement between support surface sections 28 and guide structures 30 permits adjustments to allow for interposed openings (e.g., gap 32) of varying dimensions. Such openings will be desirable in certain situations, for example to accommodate a saw blade through the opening. In addition, the workpiece support sections and guide structures may be configured, as depicted, to form an interlocking interface 34. This prevents support surface sections 28 from separating from, or moving relative to guide structures 30 in any direction other than parallel to the guide structures in the indicated direction. Support surface sections 28 may be fixed in place along the guide structures via operation of one or more set screws 36 or like locking structures.

It will be appreciated that a number of guide structures and support surface sections may be provided in various sizes, to allow for a large number of different configurations for workpiece support assembly 22. This is but one of several ways in which the described tool system is scalable, allowing it to be employed in applications ranging from small-scale uses (e.g., home hobbyist applications) to large scale industrial uses.

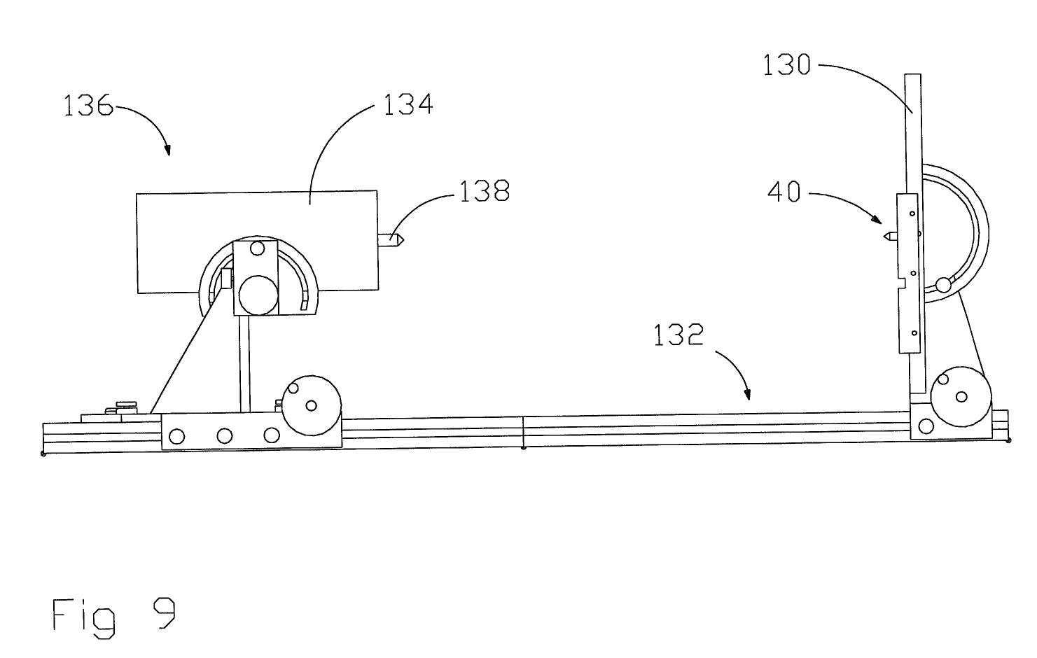

Workpiece support 24, or one of its support surface sections 28, may further be provided with a removable insert 38 adapted for specific applications. For example, one such insert includes, for router tool configurations, a hole sized to accommodate the router bit. Another insert includes a pivot, such as pivot 40 shown in FIG. 9, for holding wood, metal or other material to be acted upon in a lathe application. It will be understood that a wide variety of such inserts may be provided, further enhancing the flexibility of the tool system. Workpiece support may further be provided with grooves (e.g., groove 42), holes, depressions, detents, or any other structure/feature to facilitate the wide variety of applications for which the shop tool may be configured.

A foot 44 is provided at one end of the legs 26, for connecting the leg to base 16 (FIGS. 1-3). Typically, foot 44 is configured to provide a movable connection between workpiece support assembly 22 and base 16, allowing the workpiece support assembly to translate relative to the base. Details of this movable connection will be described below.

Opposite foot 44, workpiece support assembly may include a pivoting connection 46 between workpiece support 24 and leg 26. Typically, this pivoting connection is adapted to permit pivoting of workpiece support 24 about an axis 48, which is perpendicular to the long axis of base 16 (e.g., the x-axis depicted in FIGS. 1-3). It will be appreciated, however, that the workpiece support may be configured to pivot about any other suitable axis or move in any other desired direction. Pivoting connection 46 may be implemented via a pivot hinge 50 securing the underside of the workpiece support to the upper end of leg 26. Where rails 30 are used, the pivot hinge may be secured to one of the rails, typically near the midpoint of the rail assembly. A protractor member 52 may be provided in connection with pivot hinge 50 to facilitate tilting workpiece support 24 at a desired angle relative to leg 26 and/or base 16. The workpiece support is retained in place via a thumb screw or clamp mechanism 54 which clamps the protractor member in place against leg 26. Referring now to FIG. 5, an embodiment of a tool mount assembly which may be employed with the present invention is depicted generally at 60. Tool mount assembly 60 includes a carriage base or foot 62 and a dais structure 64 including a tool support surface (e.g., platform 78). Platform 78 preferably is configured to allow mounting of a wide variety of tools thereon, either via direct mounting to the platform or by securing the tool to the output shaft of a motor mounted on the platform. FIG. 1 depicts an embodiment of the tool system employing such a motor 18 with an output shaft 20. The tool mount assembly is configured to accommodate mounting of a wide variety of tools and components for use in saw, drill press, grinder, sander, shaper, router, lathe, joining and other applications. As will be explained in more detail, the tool mount base typically is configured to permit translation of the tool mount assembly relative to base 16 (FIGS. 1-3) along axis 66 (e.g., corresponding to the x-axis shown in FIGS. 1-3).

Dais structure 64 typically is configured to provide tool mount assembly 60 with the ability to rotate a mounted tool about one or more axes relative to base 16. In particular, dais structure 64 may be provided with a circular base 68 that is disposed within a conforming aperture 70 provided in foot 62. Circular base 68 forms a sliding interface with the aperture, allowing the dais structure to rotate relative to the tool system base as indicated about axis 72 (e.g., the z-axis of FIGS. 1-3). Clips 74 or like retaining structures may be provided to secure circular base 68 in a desired location.

Dais structure 64 may further include guide members 76 extending perpendicularly from circular base 68. Platform 78 may be movably secured to guide members 76 via a gear structure 80 or other mechanism configured to permit adjustment of the platform relative to circular base 68 along guide members 76.

Gear structure 80 typically is similar for both of guide members 76, and may include one or more user-actuable adjustment mechanisms, such as knobs 82. Knobs 82 are coupled via a bar or shaft with concentrically aligned circular gears that are disposed within gear structure 80 and engaged with gear tracks 84, which are provided along the length of guide members 76. Rotation of knobs 82 adjusts the translational displacement of platform 78 relative to foot 62 and the base of dais structure 64.

In addition to, or instead of pivoting about axis 72, dais structure 64 may be configured to provide tool rotation about one or more other axes, such as axis 86. In the depicted embodiment, platform 78 is pivotably coupled to the gear structures (i.e., structures 80) that translate up and down upon rotation of knob 82, so as to allow rotation about axis 86. Positioning of the platform at a desired angle may be facilitated by protractor members 88 affixed to the sides of platform 78. Protractor members 88 (and thus platform 78) may be fixed in place at any desired angle through selective operation of a clamping structure 90 or like mechanism. In the depicted exemplary embodiment, this second rotational axis (i.e., axis 86) is perpendicular to the first rotational axis (i.e., axis 72). This permits an at least partially spherical range of motion for tools or other structures mounted to platform 78, as previously described with reference to FIGS. 1-3. Alternatively, where two axes of rotation are used, the rotational axes may be provided at different orientations relative to each other (i.e., non-perpendicular) or to the base of the tool system. Additionally, the dais structure may be configured to pivot about only one axis, or about more than two axes, positioned at any desired orientation(s) relative to the base of the tool system.

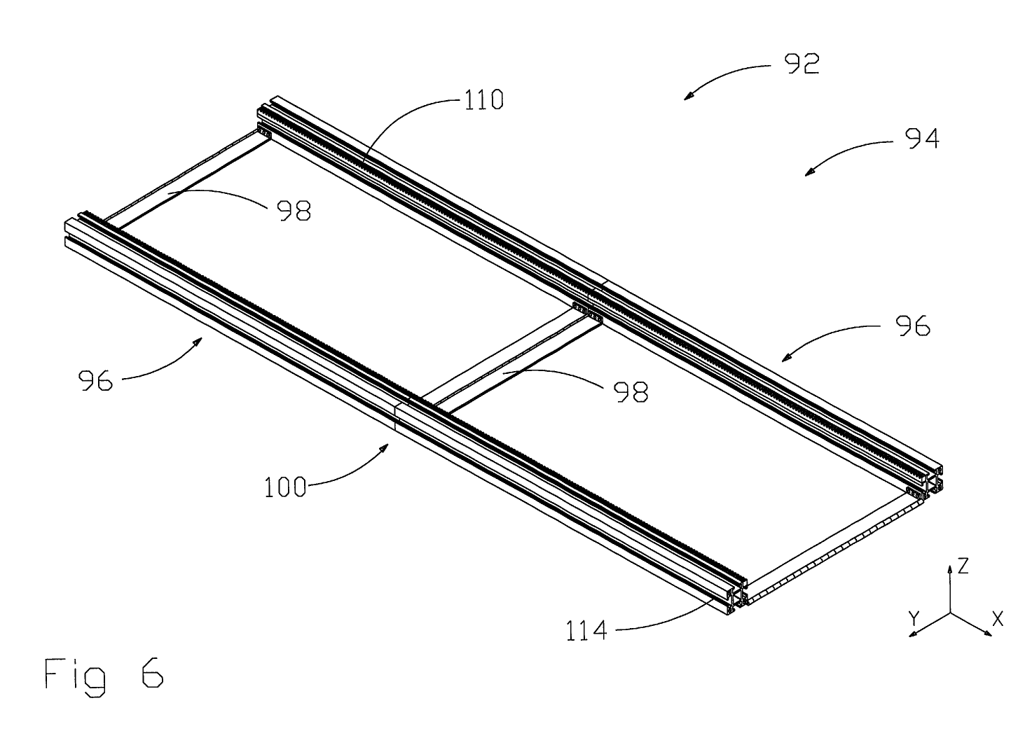

Referring now to FIG. 6, an embodiment of a base which may be used with present invention is depicted generally at 92. Base 92 typically includes a way assembly 94 having a pair of spaced apart parallel way members 96. Typically, a cross-brace 98 or like structure extends between the way members. As seen in FIG. 6, and in FIGS. 1-3, the shop tool base may form an elongate rail or track-like structure along which the various other tool system components (e.g., tool mount assembly 12 and workpiece support assembly 14) may be moved as desired for a given application. Way members 96 may be formed as elongate rails having a rectangular cross-section, as indicated, or in any other desired configuration. The depicted rectangular cross-section design may be desirable in some instances to increase the torsional rigidity of the connection between the way member and the mounted components.

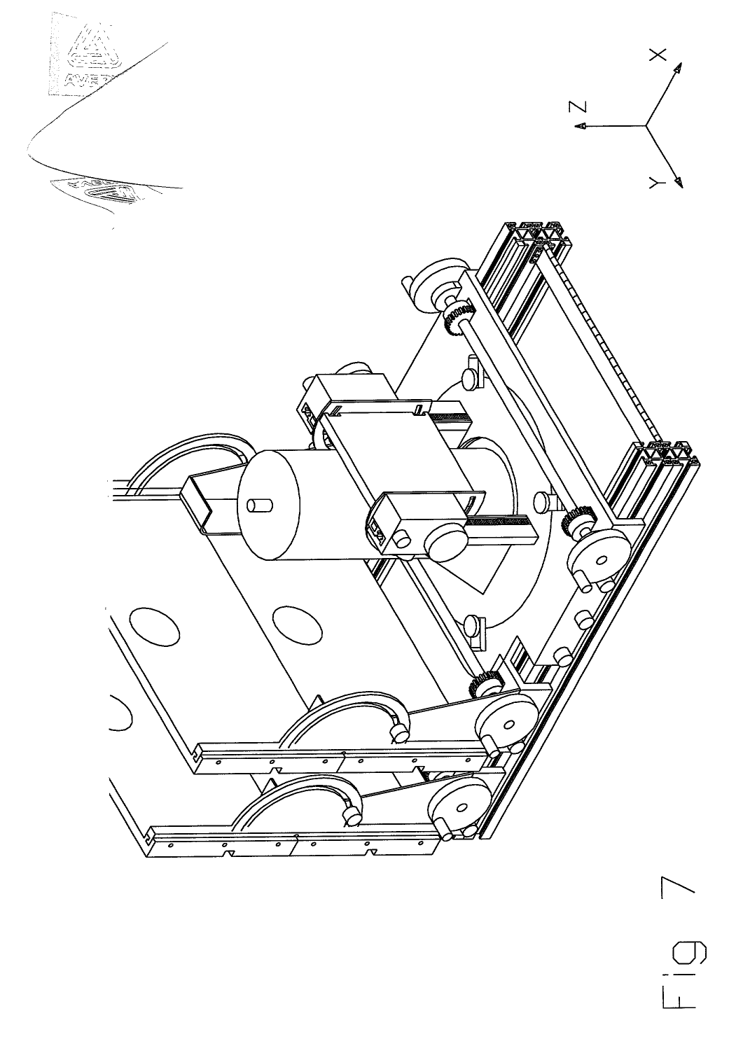

As discussed above, scalability, portability and flexibility are among the many significant benefits of the depicted tool system. Various aspects of the way assembly design contribute to these benefits. First, unlike conventional systems, way assembly 94 is modular and may be easily modified or adjusted by the user to have any desired length. To accomplish this, additional way members 96 of varying length may be selectively inserted and removed to adjust the overall length of the way assembly. The system is thus scalable to suit a wide range of applications, and to flexibly accommodate workpieces and tool configurations of virtually any desired size. To increase portability, certain way members may be hinged, as seen in the hinged way connection 100 of the exemplary embodiment depicted in FIG. 6. This allows the tool system to be easily folded into a stowed configuration, such as that shown in FIG. 7.

The described tool mount and workpiece support assemblies typically are mounted to the shop tool base by movably engaging a bottom, or foot portion of the respective component with elongate way members 96 (FIG. 6). For example, as seen in FIG. 4, workpiece support assembly 22 includes a foot 44 on the portion of leg 26 which is opposite support surface 24. Foot 44 contacts way members 96 when the workpiece support assembly is placed onto way assembly 94 (FIG. 6).

Foot 44 typically includes a gear mechanism 102 or other advancement mechanism to facilitate translation back and forth along the shop tool base. Gear mechanism 102 includes concentrically aligned circular gears 104, which typically are mounted on a shaft 106 and operable via rotation of a crank 108 or other actuating mechanism. When workpiece support 24 is placed onto way assembly 94, gears 104 mesh with a gear track 110 (FIG. 6) provided on elongate way members 96. In this configuration, it will be appreciated that the gear mechanism may be operated via crank 108 to advance workpiece support assembly 22 back and forth along the way assembly as desired.

Retention mechanisms, such as posts 112 (FIG. 4), may be provided on foot 44 in order to retain the workpiece support assembly in position on the way assembly. Typically, posts 112 are movable between an engaged and a disengaged position. In the engaged position, the posts are slidably received within lengthwise retention slots 114 provided along the sides of elongate way members 96 (FIG. 6). This prevents disengagement of workpiece support assembly 22 from the base of the tool system. To remove the workpiece support assembly from the base of the tool system, the posts are simply retracted outward from the slots (i.e., into the “disengaged” position). This engagement/disengagement mechanism provides a significant advantage over conventional rail-type systems. These conventional systems typically employ tubular rails, which are completely surrounded (i.e., the rail cross section is completely surrounded) by the connecting foot structures of the component to be mounted on the rail. As a result, the component cannot be mounted directly onto an intermediate location along the rail. Instead, the connecting foot must be inserted onto an end of the tubular rail and slid along the rail into the desired position.

As seen in FIG. 5, a tool mount assembly according to the invention may be provided with similar structures to create a movable connection with way assembly 94. In some configurations, it will be desirable to movably couple other types of components—i.e., components other than tool mounts and workpiece supports—to the base of the tool system. For these other components, the described foot, gear and retention mechanism structures will usually be appropriate. In addition, though the depicted system employs gear-type mechanisms, a variety of other suitable structures may be used to couple the base of the shop tool with tool mounts, workpiece supports and other shop tool components. Examples of such other structures include sliding connections, ratchet systems and the like.

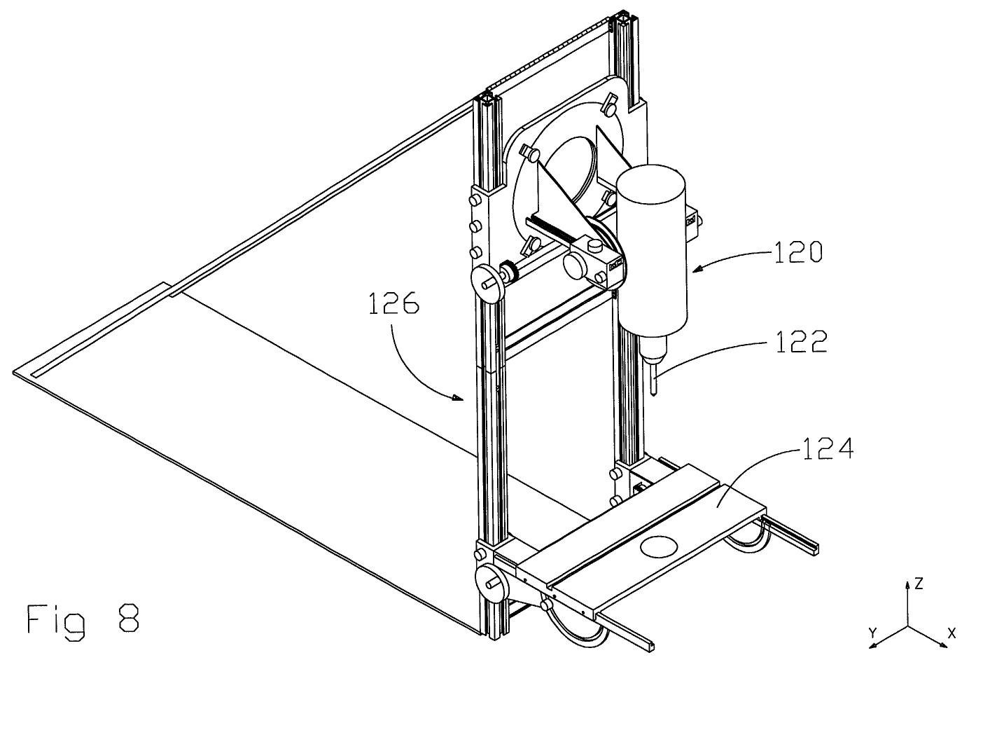

FIGS. 8-12 illustrate shop tool embodiments according to the invention, as employed in a variety of different applications. As will be seen, the embodiments shown in these figures variously include some or all of the previously described components, though the depicted components are configured to perform a particular function. In FIG. 8, the depicted shop tool is configured for use as a drill press. As indicated, it may be desirable in drill press applications to flip the entire shop tool onto its end, so that tool mount assembly 120, and thus drill bit 122, may be moved up and down in a vertical direction, similar to a conventional drill press. This vertical translation of drill bit 122 relative to a workpiece (e.g., a piece of wood resting on workpiece support 124) may be achieved by translating one or both of the tool mount and workpiece support vertically along way assembly 126. Typically, workpiece support 124 is pivoted until perpendicular to the motion of drill bit 122, and is maintained stationary along way assembly 126. Drilling is then performed by moving drill bit 122 up and down via operation of an advancement mechanism (e.g., the previously described gear and crank mechanisms). Due to the great degree and range of movement provided by the previously described tool mount and workpiece support, the depicted drill press is substantially more flexible than a conventional drill press. In particular, drilling may be performed at greater depths and on thicker objects than is possible with a conventional drill press, due to the large range of movement afforded to tool mount 120 by way assembly 126.

FIG. 9 depicts a tool system according to the present invention as deployed in a lathe configuration. As with the drill press application, workpiece support 130 typically is pivoted so that it is perpendicular to the rails of way assembly 132. As previously described, pivot piece 40 is affixed to workpiece support 130, for example by installing a removable insert as described with reference to FIG. 4. Motor 134 is mounted as part of tool mount assembly 136 so that motor output shaft 138 and pivot piece 40 are aligned and configured to rotate a workpiece (e.g., a piece of wood or metal) to be acted upon in the lathe operation. The depicted system may be flexibly deployed in a variety of different lathe configurations. For example, the system may be adjusted to accommodate workpieces of varying length by moving tool mount assembly 136 and/or workpiece support 130 along the length of way assembly 132, as previously described.

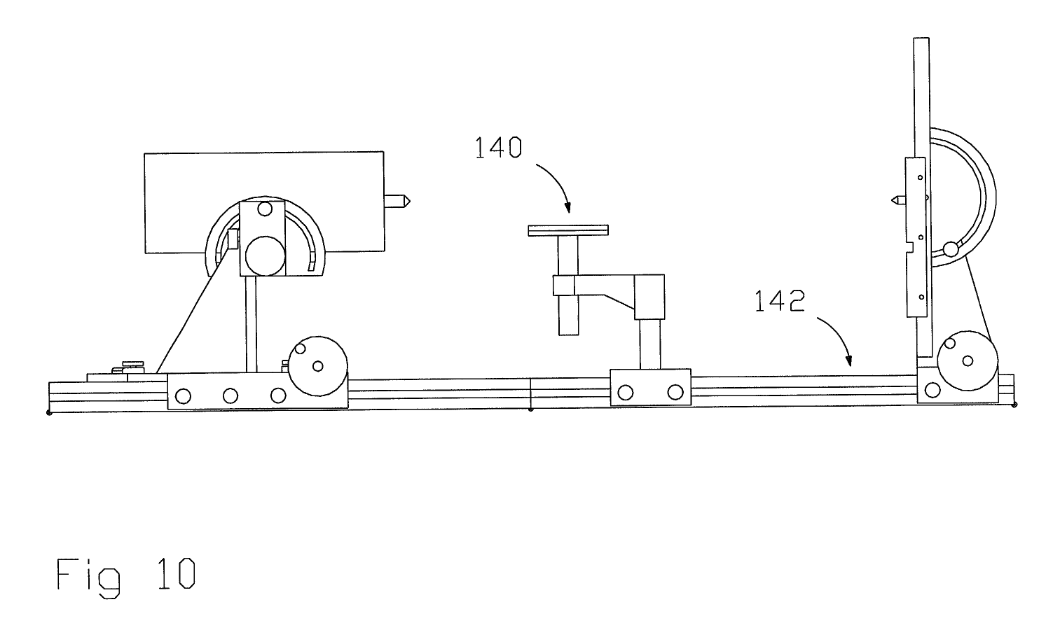

FIG. 10 depicts the shop tool in an alternate lathe configuration which further illustrates the flexibility of the shop tool. In this configuration, an additional accessory component has been mounted on the way assembly, in the form of a tool rest 140. Tool rest 140 may be configured to provide a support for various different tools used in lathe applications to shape a workpiece. Similar to the previously described tool mounts and workpiece supports, tool rest 140 may be configured in a variety of different ways in order to provide desired movements and/or allow the tool rest to be placed in a desired position relative to shop tool base 142.

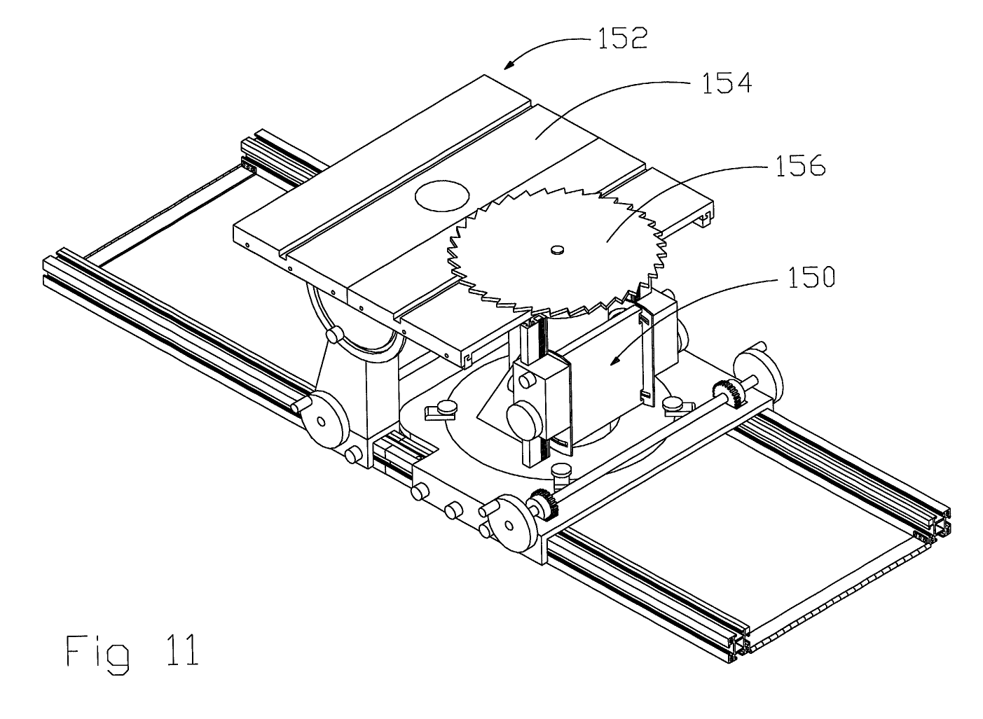

FIG. 11 depicts a shop tool according to the present invention, as configured for use in a saw application. Tool mount assembly 150 and one or more workpiece support assemblies 152 may be placed in a nearly limitless number of configurations to perform sawing operations. Using FIG. 1 as an example, a saw blade may be attached to motor output shaft 20 and used to make cuts in a workpiece in a direction perpendicular to the long axis of base 16. Alternatively, or additionally, tool mount assembly 12 and/or workpiece support assemblies 14 may be translated and/or pivoted, as previously described, to provide alternate saw configurations. FIG. 11, for example, depicts a less common sawing configuration, in which tool mount assembly 150 is manipulated so that saw blade 156 is parallel to the plane of workpiece support surface 154. The multiple degrees of freedom provided by the described tool mounts and workpiece supports allow for this and a wide variety of other configurations, such that tool system is extremely flexible when used as a saw.

FIG. 12 depicts a shop tool according to the present invention, as configured for use in a joiner application. [Michael—please briefly explain what FIG. 12 shows]

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A tool system, comprising:
a workpiece support;
a tool mount assembly including a tool mount configured to enable mounting of a variety of different tools thereon; and
a base to which the workpiece support and tool mount assembly are operatively secured,
where the tool mount assembly is configured to permit rotation of the tool mount relative to the base about multiple axes of rotation.

2. The tool system of claim 1, where the base includes a way assembly having a way member to which the tool mount assembly is movably secured so as to permit translation of the tool mount relative to the base along the way member.

3. The tool system of claim 2, where the way assembly is modular to permit selective insertion and removal of one or more additional way members to provide the way assembly with an adjustable length.

4. The tool system of claim 2, where the way assembly includes an elongate rail to which the tool mount assembly is movably secured, the elongate rail having a rectangular cross section.

5. The tool system of claim 2, where the tool mount assembly and way member are engaged via a gear structure, which is operable to cause selective advancement of the tool mount assembly relative to the base.

6. The tool system of claim 1, where the tool mount assembly is configured to permit rotation of the tool mount relative to the base about first and second axes which are perpendicular to one another, thereby providing a range of relative motion between the tool mount and base which is at least partially spherical.

7. The tool system of claim 1, further comprising a motor mounted upon the tool mount, the motor having an output shaft.

8. The tool system of claim 1, where the workpiece support is one of a plurality of workpiece supports that are each pivotable relative to the base.

9. The tool system of claim 1, where the workpiece support is pivotable relative to the base.

10. The tool system of claim 9, where the workpiece support and tool mount are translatable relative to the base.

11. The tool system of claim 10, where the workpiece support and tool mount are translatable relative to the base along an axis via operation of a gear mechanism.

12. The tool system of claim 1, where the tool mount and workpiece support are configurable to permit operation of the tool system as a lathe.

13. A tool system, comprising:
a workpiece support;
a tool mount configured to enable mounting of a variety of different tools thereon; and
a base to which the workpiece support and tool mount are operatively secured, including a way assembly with at least one way member, the tool mount being movably engageable with the way member to permit translation of the tool mount relative to the base along the way member, where the way assembly is modular to permit selective insertion and removal of one or more additional way members to provide the way assembly with an adjustable length.

14. A kit for enabling a user to flexibly deploy a tool system in a variety of different configurations, comprising:
a way assembly including plural elongate way members configured to permit mounting of various tool system components thereon to permit selective operation of the tool system in one of a saw configuration, a drill press configuration, a router configuration and a lathe configuration;
a workpiece support configured to be movably secured to the way assembly to enable the user to selectively position the workpiece support in order to support a workpiece in a desired location relative to the way assembly; and
a tool mount assembly configured to be mounted onto the way assembly to operatively secure a tool to the way assembly, the tool mount assembly being further configured to permit translation and rotation of the tool relative to the way assembly.

15. The kit of claim 14, where the way assembly is modular to permit selective insertion and removal of one or more additional elongate way members to provide the way assembly with an adjustable length.

16. The kit of claim 14, where the tool mount assembly is configured to permit rotation of a tool relative to the way assembly about multiple axes of rotation.

17. The kit of claim 16, where the tool mount assembly is configured to permit rotation of a tool relative to the way assembly about a first and second axis which are perpendicular to one another, to provide the tool with an at least partially spherical range of motion relative to the way assembly.

18. The kit of claim 14, where the workpiece support is configured to pivot relative to the way assembly when secured to the way assembly.

19. The kit of claim 14, where the elongate way members include elongate rails having rectangular cross sections.

20. The kit of claim 14, where at least one of the workpiece support and tool mount assembly are configured to be secured to the way assembly via gear structure operable to cause selective relative motion between the way assembly and the at least one of the workpiece support and tool mount assembly.
